(19) United States
(12) Patent Application Publication
(10) Pub. No.: US 2016/0158948 A1
(43) Pub. Date: Jun. 9, 2016

(54) Razor Cartridge Guard Structure

(71) Applicant: The Gillette Company, Boston, MA (US)

(72) Inventors: Christopher Raymond Eagleton, Devizes (GB); Christopher Martin Hawes, Reading (GB)

(21) Appl. No.: 14/948,982

(22) Filed: Nov. 23, 2015

Related U.S. Application Data
(60) Provisional application No. 62/088,934, filed on Dec. 8, 2014.

(51) Int. Cl. B26B 21/40; B26B 21/44

(52) U.S. Cl. CPC B26B 21/4018; B26B 21/443

(57) ABSTRACT

A razor cartridge is provided comprising at least one blade having a cutting edge; a blade unit holding the at least one blade; and a guard positioned in front of the blade unit having a fixed end joined to the blade unit and a free end, with a pivot axis between the fixed end and the free end located distally away from the blade unit, wherein the free end pivots about said pivot axis.

### FIELD OF THE INVENTION

This invention relates to a razor cartridge, and more particularly to a guard structure of the razor cartridge

### BACKGROUND OF THE INVENTION

In general, a razor cartridge of a safety razor has a blade unit with at least one blade having a cutting edge, which is moved across the surface of the skin being shaved by means of a handle to which the razor cartridge is attached. The cartridge may be mounted detachably on the handle to enable the cartridge to be replaced by a fresh cartridge when the blade sharpness has diminished to an unsatisfactory level, or it may be attached permanently to the handle with the intention that the entire razor be discarded when the blade or blades have become dulled. Razor cartridges usually include a guard which contacts the skin in front of the blade(s) and a cap for contacting the skin behind the blade(s) during shaving. The cap and guard may aid in establishing the shaving geometry, i.e., the parameters which determine the blade orientation and position relative to the skin during shaving, which in turn have a strong influence on the shaving performance and efficacy of the razor. The guard may be generally rigid, for example formed integrally with a frame or platform structure which provides a support for the blades.

Guards are present on many shaving razors and are intended to stretch the skin; however, these guards also have a propensity to press hair against the skin. Moreover, some standard shaving razor guards have a generally rigid, hard surface with minimal ability to conform to the undulations of the skin found on the body, particularly around the jaw line for men and the knee and armpit areas for women. It would be desirable to have a guard structure, which can more readily provide adequate shaving performance attributes such as skin management, efficiency and safety, with a particular improvement in conforming to the user's skin. Various razors with known guard and cap structures have been disclosed. See, e.g., U.S. Pat. Nos. 5,092,042, 5,003,694, 5,056,222, 5,689,883, 5,903,979, and 5,915,791; and US Patent Pubs 2003/0204954 and 2003/0217470. Despite the many razor executions that have been described, there still remains a need for a new type of razor that can provide a different shaving experience, in particular with regard to how the razor contacts skin.

### SUMMARY OF THE INVENTION

In one embodiment, a razor cartridge is provided comprising at least one blade having a cutting edge; a blade unit holding the at least one blade; and a guard positioned in front of the blade unit having a fixed end joined to the blade unit and a free end, with a pivot axis operably connecting said fixed end and said free end such that said free end pivots about said pivot axis, said pivot axis positioned distally away from said blade unit. In one embodiment, the free end is at least partially, or entirely, disposed over the fixed end, and a gap exists between the free end and the blade unit. The free end may have a curved profile. The free end may be formed of a first material and a layer of a second material may be disposed on the free end. Certain implementations of this embodiment of the razor cartridge may include one or more of the following features. The first material may be different than the second material. The second material may be selected from a variety of different materials that are suitable for use on the skin contacting surface of a razor cartridge. Non-limiting examples of suitable materials include thermoplastic elastomers (which can be smooth, or textured to provide different skin feel such as with the addition of fins or other commonly used surface treatments, see e.g. U.S. 2010/0313424, U.S. Pat. No. 6,675,479, U.S. Pat. No. 6,651,342, and U.S. Pat. No. 8,186,062), a lubricious material such as a lubricating shaving as described herein, a Ribbon of Moisture such as present on Venus Embrace razor or see e.g. U.S. Pat. No. 5,711,076, and U.S. Publication No. 2012/0090189, or combinations thereof, such as where the thermoplastic elastomer is coated with a lubricous material. In one embodiment, the first material is the same material that also forms the fixed end, and the second material is a coating or other feature present on part or all of the skin contacting surface of the free end.

The gap between the free end and the blade unit may be about 0.5 millimeters to about 2.5 millimeters. The pivot axis between the fixed end and the free end may be below a bottom surface of the blade unit. The free end of the guard may extend above a shaving plane of the blade unit. The guard may extend about 1 millimeter to about 10 millimeters in front of the blade unit. The pivot axis between the fixed end and the free end may have a thickness of about 0.1 millimeters to about 10 millimeters.

In another embodiment, a razor cartridge is provided comprising at least one blade having a cutting edge; a blade unit holding the at least one blade; and a guard positioned in front of the blade unit having a fixed end, a free end, and a pivot axis connecting the ends, wherein the pivot axis is positioned distally away from the blade unit and the free end is positioned intermediate the pivot axis and the blade unit. Certain implementations of this embodiment of the razor cartridge may include one or more of the following features. The free end may have a curved profile. The fixed end may be positioned between a first end and/or a second end of the blade unit and the pivot axis. The fixed end may be positioned about a perimeter of the free end. The fixed end may extend between a cap and the pivot axis. The fixed end may extend between the blade unit and the pivot axis. The pivot axis between the fixed end and the free end may be below a bottom surface of the blade unit. The free end of the guard may extend above a shaving plane of the blade unit. The guard may extend about 1 millimeter to about 10 millimeters in front of the blade unit. The pivot axis between the fixed end and the free end may have a thickness of about 0.1 millimeters to about 10 millimeters.

Other features and advantages of the invention will be apparent from the following detailed description and from the claims.

### BRIEF DESCRIPTION OF THE DRAWINGS

Embodiments of the invention will hereinafter be further described, by way of example, with reference to the accompanying drawings, in which like designations are used to designate substantially identical elements, and in which:

FIG. 1 is a perspective view of an embodiment of a razor cartridge of the present invention;

FIG. 2 is a side view of the razor cartridge of FIG. 1;

FIG. 3 is a schematic diagram of a guard which may be incorporated into the razor cartridge of the present invention; and

FIG. 4 is a schematic diagram of another guard which may be incorporated into the razor cartridge of the present invention.

### DETAILED DESCRIPTION OF THE INVENTION

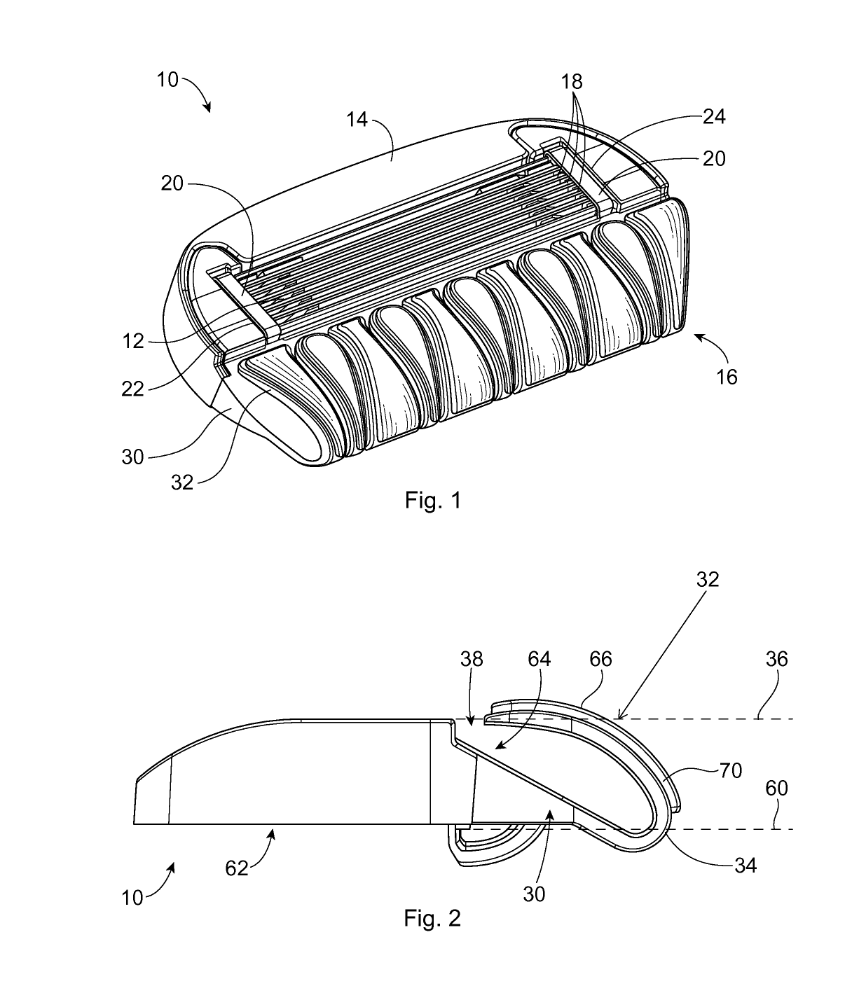

Referring to FIG. 1, one embodiment of the present disclosure is shown illustrating a razor cartridge 10 that includes a blade unit 12, a cap 14, and a guard 16. One or more blades 18 may be mounted to the blade unit 12. The blades 18 may be secured to the blade unit 12 with a pair of clips 20; however, other securing methods known to those skilled in the art may be used including, but not limited to, wire wrapping, cold forming, hot staking, insert molding, adhesives, and the like. Although five blades 18 are shown, it is understood that the blade unit 12 may have more or fewer blades 18. The blade unit 12 may include a cap 14 positioned behind the blade unit 12; behind the blade unit intended to mean disposed on a side of the blade unit 12 opposite the cutting edges of the blades 18. The guard 16 is positioned in front of the blade unit 12 opposite the cap 14, in other words, the guard 16 is disposed in front of the cutting edges of the blades 18.

As used herein, the terms “front” and “behind”, as used herein, define the relative position between features of the razor cartridge. A feature “forward” of the blade unit, for example, is positioned so that the surface to be treated by the razor cartridge encounters the feature before it encounters the cutting edge of the blade(s) in the blade unit. For example, if the razor cartridge is being stroked in its intended cutting direction, the guard is in front of the blade unit. A feature “behind” the blade unit is positioned so that the surface to be treated by the razor cartridge encounters the feature after it encounters the cutting edge of the blade(s) in the blade unit. For example, if the razor cartridge is stroked in its intended cutting direction, the cap is positioned behind of the blade unit.

The blade unit 12 may be injection molded from a semi-rigid material such as, for example, a polyphenylene oxide (PPO) and polystyrene blend, high impact polystyrene, polypropylene, acrylonitrile butadiene styrene (ABS), or any combination thereof. A semi-rigid material may allow the blade unit 12 to maintain a consistent geometry during shaving. The blade unit 12 may be of sufficient stiffness such that it does not bend or flex under normal shaving conditions, which may adversely influence the shave geometry of the razor cartridge 10.

The cap 14 is positioned behind the blade unit 12. In certain embodiments, the cap 14 may further extend about a first end 22 and a second end 24 of the blade unit 12 circumscribing three sides of the blade unit 12 with the guard 16 being disposed in front of the fourth side. In other embodiments, the cap 14 may be positioned only behind the blade unit 12, but not on the ends 22, 24 of the blade unit 12. The cap 14 may have a smooth surface and may be provide lubrication to the skin by delivering a shaving aid behind the blade unit 12. In certain embodiments, the cap 14 may include a shaving aid, which provides, for example, lubricity, skin moisturizing and conditioning properties, and the like. The cap 14 may have sufficient wear resistance such that the cap 14 lasts for the intended life of the razor cartridge 10 (e.g., the blades become too dull to effectively shave hairs). In other embodiments, the cap 14 may be injection molded from semi-rigid polymeric materials that do not wear under normal shaving conditions, such as a blend of PPO and polystyrene, high impact polystyrene, polypropylene, ABS, polytetrafluoroethylene (PTFE), high density polyethylene (HPDE), acetal, nylon, or any combination thereof. The polymeric material may also be filled with materials such as silicone, molidium disulfide, or other lubricating agents known to those skilled in the art for reducing friction against the surface of the skin. Those of skill in the art will appreciate that various shaving aids/skin engaging members can be used with the present invention. The skin engaging member can be positioned forward and/or aft of any blade(s), such as on the cap, on the guard, and/or on the free end of the guard of the present invention. Non-limiting examples of known skin conditioning compositions suitable for use herein include shave aids and lubrication strips as described in: U.S. Pat. Nos. 7,581,318, 7,069,658, 6,944,952, 6,594,904, 6,302,785, 6,182,365, D424,745, 6,185,822, 6,298,558 and 5,113,585, and 2009/0223057.

The guard 16 described herein generally extends beyond the housing of the razor cartridge 10, which generally includes the blade unit 12 and the cap 14. The guard 16 extends generally parallel to the blades 18 and is positioned in front of the blade unit 12. The guard 16 has a fixed end 30, joined to the blade unit 12, and a free end 32 attached to said fixed end about a pivot axis 34. Said pivot axis operably connects said fixed end and said free end such that said free end pivots about said pivot axis. Operably connected, as used herein, means that the free end is permanently or removably attached to said fixed end about a pivot axis in any manner that allows the free end to hingedly rotate about said pivot axis while remaining securely attached to said fixed end during use. In one embodiment, the fixed end and the free end are formed of the same structure (i.e., such as an embodiment where a portion of the razor housing that extends away from the blade unit, and folds onto itself about the pivot axis). Those of skill in the art will understand that examples shown and described herein as well as other similar executions are within the scope of the present invention. In one embodiment, the free end is at least partially, or entirely, disposed over the fixed end, and a gap exists between the free end and the blade unit.

The guard 16 deflects transversely relative to the blade 18 to follow the contours of the skin. Without intending to be bound by theory, it is believed that by conforming to the skin, by conforming to the skin, the guard 16 as described herein may enhance skin stretching and provide a more pleasant feel against the skin of the user during shaving, helping to provide a close shave. The flexibility of the guard 16 to conform to contours of a user's skin may tend to increase the surface area of the guard 16 that contacts the user's skin, enhancing skin stretch, and more uniformly distributing the force applied by the user during shaving. The guard 16 uniquely has a pivot axis isolated (e.g., positioned away and not adjacent to) from the blade unit 12 and/or the cap 14. The position of the pivot point in the guard 16 permits the contouring movement of the guard to be at least at the point of the guard nearest the blades 18, which may help stretch out the skin and put the hairs in a desirable position just before the cut. Without intending to be bound by theory, it is believed the guard of the present invention can provide new and different shave experience during usage. It is further believed that depending on the usage conditions, this guard can provide users with different and more preferred skin stretching, or a different feel of resistance when applying a downward shave stroke.

In one embodiment, the guard comprises one or more lubricating members. Said lubricating members can be made of the same materials as used for the lubricating member optionally available on the cap, or can be made of different materials. In another embodiment, the guard comprises one or more fins. See, e.g., U.S. 2010/0313424, and U.S. Pat. No. 6,675,479. In one embodiment, the guard comprises one or more lubricating members and one or more fins.

FIG. 2 is a side view of the razor cartridge 10. As can be more clearly seen in FIG. 2, a pivot axis 34 exists between the fixed end 30 and the free end 32 of the guard 16. The free end 32 is at least partially disposed over the fixed end 30, such that the pivot axis 34 permits movement of the free end 32 in a direction generally transverse relative to the blades 18. One of skill in the art will understand that while described as individual elements of the razor cartridge, the housing, blade unit, cap, and various components of the guard (e.g., the fixed end) may be formed of the same material, such as where they are injection molded as a unitary structure.

As illustrated in FIG. 2, the fixed end 30 may be joined to the blade unit 12 at a point below the shave plane 36 of the razor cartridge 10. As used herein, “shave plane” is intended to mean a plane that is tangent to two or more of the cutting edges of the blades 18. For example, the blade 18 closest to the guard 16 and the blade 18 furthest from the guard 16 may define and be tangent to the shave plane. Additional blades 18 may be positioned above, below, or on the shave plane 36. In another embodiment, the fixed end 30 of the guard 16 may be joined to the cap 14. For example, the cap 14 may extend about the ends 22, 24 of the blade unit and connect with at least a portion of the fixed end 30. This may be the only connection of the guard 16 to the razor cartridge 10, or the guard 16 may be connected to both the cap 14 and the blade unit 12. When the guard 16 is joined only through connection of the fixed end 30 to the cap 14, an aperture may exist in front of the blade unit 12, between the connection points of the guard 16 and the cap 14. The guard 16 may be joined to the blade unit 12 and/or the cap 14 by insert molding or co-injection molding. Other mechanical or chemical assembly/securing methods known to those skilled in the art may also be used to join the guard 16, such as adhesives, wire wrapping, mechanical fasteners, and the like. The fixed end 30 may be supported by the blade unit 12 and the free end 32 may be unsupported to facilitate flexing of the free end 32 under normal shaving forces.

In one embodiment, the free end 32 is at least partially disposed over the fixed end 30. In some embodiments, the free end is wholly disposed over the fixed end, meaning no portion of the free end extends beyond a corresponding portion of the fixed end when a user looks at the shaving razor from a top view perpendicular to the shave plane. In one embodiment, the entire fixed end can be obscured by the free end when looking from this same top view. As used herein, the term “disposed over” is generally intended to mean that the position of one feature is located closer to the shave plane than another feature. For example, in the embodiment of FIG. 2, the free end 32 is disposed over the fixed end because the free end is positioned closer to the shave plane (whether below or above the plane) than the fixed end 30.

The free end 32 is disposed over the fixed end 30, such that the pivot axis 34 permits movement of the free end 32 in a direction generally transverse relative to the blades 18. The free end 32, as illustrated in FIG. 2, has a generally curved profile, but numerous other profiles are possible, such as straight, angled, and the like. At least a portion of the free end 32 extends above the shave plane 36. By extending above the shave plane, the guard 16 engages the user's skin first. The pivot axis 34 permits movement of the free end 32 when under load during normal shaving conditions such that the free end 32 deflects down to or below the shave plane 36, providing the user with a sense of comfort and closeness during the shave. As shown in FIG. 2, a gap 38 may exist between the free end 32 and the blade unit 12. The gap 38 may provide for the unobstructed passage of hair to the blades 18. The gap 38 may further provide space for shave preps, such as shaving cream, to pass through to help prevent the guard 16 from being clogged with shave prep, shaved hairs, and the like. The gap 38 may also help to generally improve the rinsability of the razor cartridge 10. The gap 38 between the free end 32 and the blade unit 12 may be about 0.5 millimeters (“mm”) to about 2.5 mm; specifically about 0.75 mm to about 2 mm; and more specifically about 1 mm to about 1.5 mm.

As stated, the pivot axis 34 permits movement of the free end 32 when under load during normal shaving conditions such that the free end 32 deflects down, providing the user with a sense of comfort and closeness during the shave. When the load is removed, such as when the razor cartridge 10 is separated from the skin, the free end 32 returns generally to the original position. During a shave stroke, the free end 32 of the guard 16 deflects in a direction transverse to the blades 18. The amount of deflection of the free end 32 may vary as the guard 16 follows the contours of the skin during shaving. As the razor cartridge 10 glides across the surface of the skin, the guard 16 may stretch the skin to reduce skin bulges (which can lead to nicks and cuts).

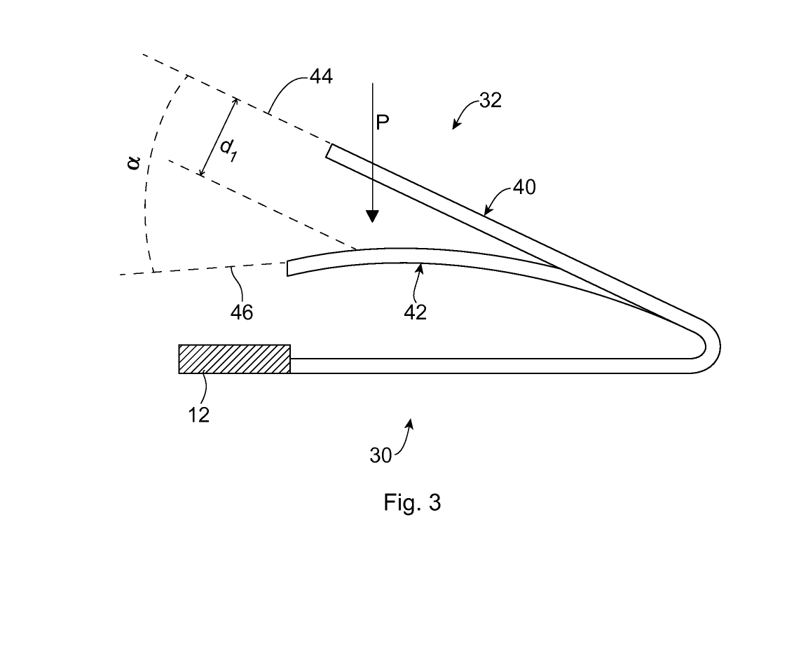

Referring to FIG. 3, a schematic diagram representing the free end 32 of the guard 16 is shown. The free end 32 is movable between a first position 40 and a second position 42. In the first position 40, at least a portion of the free end 32 may have a longitudinal axis 44 that extends transverse to the blade unit 12. The free end 32 may be unloaded in the first position 40 such that the free end is not deflected relative to the blade unit 12. During shaving, the force of razor cartridge 10 against the surface of the skin may apply a load P, which causes the free end 32 to deflect resulting in the second position 42. In the second position 42 (e.g., during shaving), at least a portion of the free end 32 may have a longitudinal axis 46 that is deflected at an angle relative to the longitudinal axis 44 (e.g., below the longitudinal axis 44). An angle of deflection α₁ of the longitudinal axis 46 of the free end 32 relative to the longitudinal axis 44 (and/or the blade unit 12) may be about 5 degrees to about 40 degrees; specifically about 10 degrees to about 30 degrees; and more specifically about 15 degrees to about 25 degrees. While FIG. 3 illustrates a bending of the free end 32, resulting in an angle of deflection α₁, it is to be understood that free end could also deflect linearly a distance d₁ with no curving of the free end resulting in an angle of deflection. Whether or not the free end 32 bends rather than simply deflecting about the pivot axis 34 may depend on the profile of the free end 32, the thickness of the pivot axis and/or the free end, the gap 64 between the free end and the fixed end 30, combinations thereof, and the like, and such construction of the guard 16 to produce a desired deflection distance and/or angle is within the skill of a person in the art.

The applied load may cause the free end 32 to deflect a distance d₁ of about 0.1 mm to about 4 mm; specifically about 0.5 mm to about 3 mm; and more specifically about 1 mm to about 2 mm. The force needed for the applied load to deflect the free end 32 by the distance d₁ may vary depending on where along the length of the free end 32 the load P is applied, as well as the geometry and dimensions of the guard 16. The width and unsupported length of the free end 32, and the thickness t₁ of the pivot axis 34 may all be varied to increase or decrease the force required to deflect the free end 32. For example, one particular embodiment of the guard 16 which may provide sufficient flexibility may include a pivot axis 34 with a thickness of about 0.1 mm to about 10 mm; or from about 0.5 millimeters to about 5 millimeters, or from about 1 millimeter to about 2.5 millimeters. Moreover, the positioning of the pivot axis 34 relative to the blade unit may affect the flexibility and load requirements of the guard 16. In one embodiment, the pivot axis 34 is positioned below a plane 60 of the bottom surface 62 of the blade unit 12 (as shown in FIG. 2). While the pivot axis described herein has been primarily referred to and illustrated as a living hinge due to its ability to form the guard as a unitary structure, it is to be understood that other well known pivot mechanisms may be used, such as hinges, joints, combinations thereof, and the like.

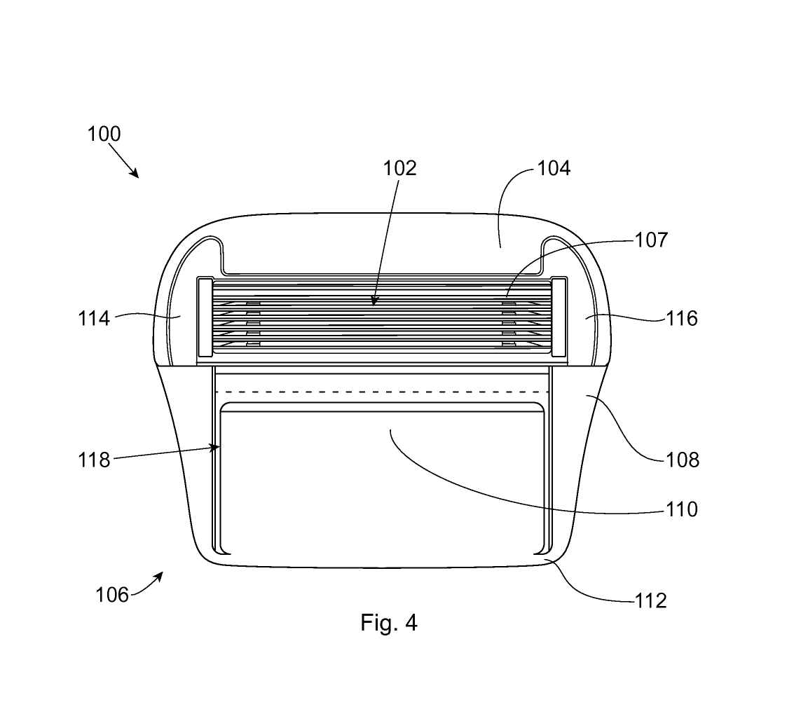

The support structure can be as described and shown herein (where a free end is folded/disposed over a fixed end and attached via a pivot axis), but can also have different designs, such as where the fixed end can be generally co-planar with the free end (such as where the fixed end comprises one or a pair of support arms wrapping around the free end and attached to the free end at a similar position as shown in FIG. 2—distally away from the forward most blade). This can be similar to the embodiment shown in FIG. 4, but with the portion of the fixed end residing below the free end being an aperture. In one embodiment, the aperture can have the same general peripheral shape as the entire free end or just a portion of the free end. In such an embodiment, it can be possible in some instances for a portion of the free end (i.e. the portion closest to the blade unit) can be pushed back towards the fixed end and at least partially through the aperture. Those of skill in the art would understand, however, that it could be preferable for an embodiment of the invention to have sufficient resistance in the pivot axis that the free end would not pass below the shaving plane when force is applied, or no more than about 0.1 mm below the shaving plane, or no more than about 0.5 mm below the shaving plane, or no more than about 1 mm below. In one embodiment, said fixed end forms an aperture and at least a portion of said free end is disposed over said aperture.

Having the bottom surface of the free end (i.e. the surface opposite the skin contacting surface) exposed it can assist with rinse ability of the entire cartridge and minimize the possibility of hairs, shaving preparation or other shaving debris from being entrapped within the varying structures of the device.

A gap 64 may also exist between free end 32 and the fixed end 30 where the free end is disposed over the fixed end. In an embodiment of the razor cartridge having such a gap 64, the distance d₁ may at least partially depend on the size of the gap 64. As shown in FIG. 2, the gap 64 exists between the distal end of the free end 32 of the guard 16 and a portion of the fixed end 30 generally near the blade unit 12. In one embodiment, the fixed end 30 may provide a hard stop for deflection of the free end 32. In other words, the distance d₁ would equal the length of the gap 64. In another embodiment, guard 16 may be designed (such as by determining the necessary thickness of the pivot axis 34, which may act as a living hinge) so that the distance d₁ is less than a length of the gap 64. The gap 64 between the free end 32 and the fixed end 30 may be about 0.5 mm to about 5 mm; specifically about 1 mm to about 4 mm; and more specifically about 1.5 mm to about 2.5 mm.

Referring to FIG. 4, another embodiment of the present disclosure is shown illustrating a razor cartridge 100 that includes a blade unit 102, a cap 104 and a guard 106. The blade unit 102 includes at least one blade 107 with a cutting edge. The cap 104 is positioned behind the blade unit 102. The guard 106 is positioned in front of the blade unit 102. The guard 106 includes a fixed end 108, a free end 110, and a pivot axis 112 connecting the ends. The pivot axis 112 is positioned distally away from the blade unit 102 and the free end 110 is positioned intermediate the pivot axis 112 and the blade unit 102. The fixed end 108 may be connected to the blade unit 102 or the cap 104. For example, the fixed end 108 may be positioned between a first end 114 and/or a second end 116 of the blade unit 102 and the pivot axis 112. In another example, the fixed end 108 may be positioned about a perimeter 118 of the free end 110. Again, the distal positioning of the pivot axis 112 permits contouring movement of the free end 110 of the guard 106, which is disposed closer to the cutting edge of the blade(s) 107 than the pivot axis 112.

The guard 16 extends along at least a portion of the length of the blade unit 12. In one embodiment, the guard 16 may extend along the entire length of the blade unit 12. In another embodiment, the guard 16 may extend along only a portion of the length of the blade unit 12. In yet another embodiment, the guard 16 may extend beyond the entire length of the blade unit 12, such that the length of the guard 16 extends beyond one or both ends 22, 24 of the blade unit 12. The guard 16, as illustrated in FIG. 1, has a generally rectangular cross section, but numerous cross sectional shapes are possible, such as circles, squares, triangles, ovals, trapezoids, combinations thereof, and the like. The guard 16 may have a depth, as measured by the distance the guard extends in front of the blade unit 12, of about 1 mm to about 5 mm; specifically about 1.5 mm to about 4 mm; and more specifically about 2 mm to about 3 mm.

The guard 16 generally may have planar or non-planar surfaces, may be contiguous, non-contiguous, patterned, or any combination thereof. It may be made by injection molding techniques for low cost and the manufacturing simplicity of using a single material (e.g., as the housing). The guard 16 may be made of a single material, forming the fixed end, the free end, and the pivot axis, wherein the material provides suitable flexibility in the pivot axis to permit the desired deflection of the guard free end. Alternatively, the fixed end 30 and free end 32 of the guard 16 can be formed of a first material and the pivot axis 34 can be formed of a second material. Moreover, the top surface 66 of the free end 32, which engages the skin, may include a layer 70 of a second material. The second material may be different than the first material of which the free end 32 is composed. In one embodiment, the guard 16 may fully comprise a hard plastic material such as polystyrene, polyphenylene oxide, polypropelene, acrylonitrile butadiene styrene, high impact polystyrene, combinations thereof, and the like. In another embodiment, at least a portion of the guard 16, such as the free end 32, the pivot axis 34 and/or the layer 70 may comprise a material different than that of the remainder of the guard 16. For example, the free end 32, the pivot axis 34 and/or the layer 70 may include a resilient material to facilitate flexing of the free end 32 in a direction transverse to the blades 18. The resilient material may also improve tactile sensation against the skin and provide improved stretching of the skin compared to more rigid materials. For example, the resilient material may have a Shore A hardness of about 20 to about 70; specifically about 30 to about 60; and more specifically about 40 to about 50. The free end 32, the pivot axis 34 and/or the layer 70 may be molded from thermoplastic elastomers (TPEs) or rubbers; examples may include, but are not limited to silicones, natural rubber, butyl rubber, nitrile rubber, styrene butadiene rubber, styrene butadiene styrene (SBS) TPEs, styrene ethylene butadiene styrene (SEBS) TPEs, polyester TPEs, polyamide TPEs, polyurethane TPEs, polyolefin based TPEs, and blends of any of these TPEs (e.g., polyester/SEBS blend).

In one embodiment, the top surface 66 may be made of a non-wearing material which is slippery when wetted. Examples of suitable non-wearing materials include metal, glass, and hard plastics, or can include coatings to enhance slipperyness such as Teflon or ceramic coatings. In one embodiment, the non-wearable top surface 66 may be made of a polyoxymethylene, PVC, or another commercially available hard plastic material which does not have a high coefficient of friction when contacted against skin in a wet or dry situation.

The razor cartridge of the present disclosure may be used with a power or manual, disposable or a refillable razor system. The razor cartridge may also include multiple blades. For example, U.S. Pat. No. 7,168,173 generally describes a Fusion® razor that is commercially available from The Gillette Company which includes a razor cartridge with multiple blades.

It should be understood that every maximum numerical limitation given throughout this specification includes every lower numerical limitation, as if such lower numerical limitations were expressly written herein. Every minimum numerical limitation given throughout this specification includes every higher numerical limitation, as if such higher numerical limitations were expressly written herein. Every numerical range given throughout this specification includes every narrower numerical range that falls within such broader numerical range, as if such narrower numerical ranges were all expressly written herein.

All parts, ratios, and percentages herein, in the Specification, Examples, and Claims, are by weight and all numerical limits are used with the normal degree of accuracy afforded by the art, unless otherwise specified. Further, as used herein, where a group is described to be “comprising of” a list of group members, that group may also “consist essentially of” or “consist of” that same list of group members.

The dimensions and values disclosed herein are not to be understood as being strictly limited to the exact numerical values recited. Instead, unless otherwise specified, each such dimension is intended to mean both the recited value and a functionally equivalent range surrounding that value. For example, a dimension disclosed as “40 mm” is intended to mean “about 40 mm.”

Every document cited herein, including any cross referenced or related patent or application, is hereby incorporated herein by reference in its entirety unless expressly excluded or otherwise limited. The citation of any document is not an admission that it is prior art with respect to any invention disclosed or claimed herein or that it alone, or in any combination with any other reference or references, teaches, suggests or discloses any such invention. Further, to the extent that any meaning or definition of a term in this document conflicts with any meaning or definition of the same term in a document incorporated by reference, the meaning or definition assigned to that term in this document shall govern.

While particular embodiments of the present invention have been illustrated and described, it would be obvious to those skilled in the art that various other changes and modifications can be made without departing from the spirit and scope of the invention. It is therefore intended to cover in the appended claims all such changes and modifications that are within the scope of this invention.

What is claimed is:

1. A razor cartridge comprising:
at least one blade having a cutting edge;
a blade unit holding the at least one blade; and
a guard positioned in front of the blade unit having a fixed end joined to the blade unit and a free end, with a pivot axis operably connecting said fixed end and said free end such that said free end pivots about said pivot axis, said pivot axis positioned distally away from said blade unit.

2. The razor of claim 1, wherein said free end is at least partially disposed over said fixed end.

3. The razor cartridge of claim 1, wherein the free end has a curved profile.

4. The razor cartridge of claim 1, wherein the free end is formed of a first material and a layer of a second material is disposed on the free end.

5. The razor cartridge of claim 4, wherein the first material and the second material are different.

6. The razor cartridge of claim 5, wherein the second material comprises a thermoplastic elastomer.

7. The razor cartridge of claim 1, wherein the gap is about 0.5 millimeters to about 2.5 millimeters.

8. The razor cartridge of claim 1, wherein the pivot axis is below a bottom surface of the blade unit.

9. The razor cartridge of claim 1, wherein the free end extends above a shaving plane of the blade unit.

10. The razor cartridge of claim 1, wherein the guard extends about 1 millimeter to about 5 millimeters in front of the blade unit.

11. A razor cartridge comprising:
at least one blade having a cutting edge;
a blade unit holding the at least one blade; and
a guard positioned in front of the blade unit having a fixed end, a free end, and a pivot axis connecting the free end to the fixed end, wherein the pivot axis is positioned distally away from the blade unit and the free end is positioned intermediate the pivot axis and the blade unit.

12. The razor of claim 11, wherein said fixed end forms an aperture and at least a portion of said free end is disposed over said aperture.

13. The razor cartridge of claim 11, wherein the free end has a curved profile.

14. The razor cartridge of claim 11, wherein the fixed end is positioned between a first end and/or a second end of the blade unit and the pivot axis.

15. The razor cartridge of claim 14, wherein fixed end is positioned about a perimeter of the free end.

16. The razor cartridge of claim 11, wherein the fixed end extends between a cap and the pivot axis.

17. The razor cartridge of claim 11, wherein the fixed end extends between the blade unit and the pivot axis.

18. The razor cartridge of claim 11, wherein the pivot axis is below a bottom surface of the blade unit.

19. The razor cartridge of claim 11, wherein the free end extends above a shaving plane of the blade unit.

20. The razor cartridge of claim 11, wherein the guard extends about 1 millimeter to about 5 millimeters in front of the blade unit.
